(19) United States
(12) Patent Application Publication
(10) Pub. No.: US 2023/0012599 A1
(43) Pub. Date: Jan. 19, 2023

(54) COMPARTMENT FOR EQUIPMENT LIKELY TO EMIT HEAT

(71) Applicant: Valeo Systems Thermiques, La Verriere (FR)

(72) Inventors: Thibaut PERRIN, La Verriere (FR); Mohamed IBRAHIMI, La Verriere (FR); Sergio DA COSTA PITO, La Verriere (FR); Richard COTTET, La Verriere (FR)

(73) Assignee: Valeo Systemes Thermiques, La Verriere (FR)

(21) Appl. No.: 17/785,477

(22) PCT Filed: Dec. 2, 2020
(86) PCT No.: PCT/FR2020/052252

§ 371 Date: Jun. 15, 2022

(30) Foreign Application Priority Data
Dec. 17, 2019 (FR) 1914643

(51) Int. Cl. H01M 10/613; H01M 50/209; H01M 50/249; H01M 10/625; H01M 10/6554; H01M 10/6567; H01M 10/6556; H01M 50/231; H01M 50/227; H01M 50/229; H01M 50/224; H01M 50/271; B60L 50/64

(52) U.S. Cl. CPC H01M 10/613; H01M 50/209; H01M 50/249; H01M 10/625; H01M 10/6554; H01M 10/6567; H01M 10/6556; H01M 50/231; H01M 50/227; H01M 50/229; H01M 50/224; H01M 50/271; B60L 50/64; H01M 2220/20

(57) ABSTRACT

The invention relates to a compartment for equipment likely to emit heat during its operation, in particular for a device for storing electrical energy for a motor vehicle, said compartment having at least one cooling plate arranged to have a cooling fluid flowing through it and arranged to cool said equipment. The compartment further includes an upper housing arranged to accommodate said electrical equipment, and a lower housing, in which at least one fluid connection element is placed in order to supply the cooling plate with fluid, the lower and upper housing being isolated from each other in a fluidly sealed manner.

### CROSS-REFERENCE TO RELATED APPLICATIONS

This application is filed under 35 U.S.C. § 371 U.S. National Phase of International Application No. PCT/FR2020/0052252 filed Dec. 2, 2020 (published as WO2021123538), which claims priority benefit to French application No. 1914643 filed on Dec. 17, 2019, the disclosures of which are herein incorporated by reference in their entirety.

### TECHNICAL FIELD

The present invention relates to a compartment for an item of equipment liable to give off heat during its operation, in particular for an electrical energy storage device for a motor vehicle.

### BACKGROUND OF THE INVENTION

Patent applications US 2017/176108 and WO 2013/056938 describe heat exchangers for cooling battery cells. In addition, patent application US 2011/0206967 A describes an example of such a battery. In this application, the cells are stored in containers having housings for receiving the cells. A wall of the containers, intended to be in contact with a wall of a neighboring container, has depressions forming part of a duct for circulating a heat transfer fluid.

### BRIEF SUMMARY OF THE INVENTION

The aim of the present invention is in particular to improve the sealing of the compartments for receiving battery cells.

To do this, one subject of the present invention is a compartment for an item of equipment liable to give off heat during its operation, in particular for an electrical energy storage device for a motor vehicle, the compartment having at least one cooling plate which is designed to be passed through by a cooling fluid and which is designed to cool said item of equipment, the compartment comprising a bottom cover comprising at least one layer of composite material and an additional layer of non-reinforced polymer material, said additional layer in particular being impermeable to the cooling fluid.

Thus, with an additional layer of non-reinforced polymer material that is in particular impermeable to water, the sealing of the compartment is improved while retaining its mechanical properties in particular with respect to weight and mechanical resistance.

Other aspects according to the invention are described below and can be taken alone or in combination.

One aspect according to the invention provides that the housing comprises two additional layers of non-reinforced polymer material, said additional layers in particular being impermeable to the cooling fluid. The layer of composite material can be arranged between the two additional layers.

Another aspect according to the invention provides that the housing furthermore comprises a fireproof layer made of a fireproof material. Mention can also be made of a fire barrier.

Another aspect provides that the compartment has at least one channel for circulating a cooling fluid, this channel being obtained by molding of a polymer-based material, with fluid-assisted injection molding, in particular gas- or liquid-assisted injection molding, for forming this channel in the polymer-based material.

Another aspect provides that the compartment, for example for receiving battery cells, also has the function of cooling these cells, the manufacture of which is simplified.

Another aspect provides that the formation of the cooling fluid channel or channels in the polymer-based material by liquid- or gas-assisted injection molding allows for a one-step manufacturing method, instead of a multi-step method for forming the channel or channels that would require welding. The invention thus makes it possible to avoid certain sealing problems linked to cooling fluid leaks. In the invention, these leakage problems are avoided since the channel or channels are formed by hollow shapes directly in the material. The manufacturing operations are further simplified.

Another aspect provides that the channel has an internal wall without a join, which is the result of the hollowing of the polymer-based material by the fluid injected during the molding.

Another aspect provides that the channel has a cylindrical shape, at least over part of its length, in particular with a rectangular or oval or round cross section.

Another aspect provides that the polymer-based material in which the channel is formed is connected to a layer of polymer-based composite material.

This connection is in particular the result of molding, in particular overmolding or co-molding, between the material which has the channel or channels for circulating cooling fluid and this layer of composite material.

According to one of the aspects of the invention, the layer of composite material has an opening and the material that forms the channel passes through this opening such that this channel also passes through this opening of the layer.

According to one of the aspects of the invention, the material in which the channel is formed is in the form of a layer which extends over a face of the layer of composite material.

These two layers form in particular a bottom cover.

According to one of the aspects of the invention, this layer of composite material and the layer are planar over at least part of their surface area.

According to one of the aspects of the invention, these two layers have an edge that is inclined with respect to this planar part, and the channel passes into the layer of material at this edge.

According to one of the aspects of the invention, the channel in the material is connected to a fluidic connection member, in particular at this inclined edge.

According to one of the aspects of the invention, this fluidic connection member is molded with the material of the layer comprising the channel.

According to one of the aspects of the invention, the layer of composite material has at least two channels resulting from assisted injection molding, these channels being in particular parallel over the majority of their length.

According to one of the aspects of the invention, the compartment has a cooling plate disposed on a side of the layer of composite material that is opposite to the side of the layer of molded material.

According to one of the aspects of the invention, the cooling plate is designed to be passed through by a cooling fluid also circulating in the channels of the molded layer. These channels are in particular feeder channels which respectively supply and evacuate the cooling liquid circulating in the cooling plate. Provision is for example made for a single supply feeder channel and a single evacuation feeder channel.

According to one of the aspects of the invention, the layer that has the feeder channels has a connection portion which is formed in one piece with the rest of the layer and which is designed to be connected to the cooling plate. This connection portion protrudes through the layer of composite material.

According to one of the aspects of the invention, the channels are formed only in the layer of molded material, in other words the channels are not formed by the assembly of two separate layers, for example.

According to one of the aspects of the invention, the layer has grooves for forming the channels and reinforcing ribs, in particular of honeycomb shape, for mechanically reinforcing the compartment.

The molded layer thus occupies only part of the outer face of the composite layer, and not all of this face. This molded layer occupies for example less than 50% of the outer face of the layer, or even less than 25% thereof.

The invention also relates to an electrical energy storage module having a plurality of battery cells that are in particular disposed in a row, and a compartment as described above, the cells being placed in the compartment in thermal interaction with the cooling plate.

The invention also relates to a method for manufacturing a compartment for an item of equipment liable to give off heat during its operation as described above, the method having the step of forming a layer of polymer-based material, with fluid-assisted injection molding for forming a channel in this layer.

Another subject of the invention, independently or in combination with the foregoing, is a compartment for an item of equipment liable to give off heat during its operation, in particular for an electrical energy storage device for a motor vehicle, the compartment having at least one cooling plate which is designed to be passed through by a cooling fluid and which is designed to cool said item of equipment, the compartment furthermore having an upper housing designed to receive said item of electrical equipment, and a lower housing in which at least one fluid connection element for supplying fluid to the cooling plate is placed, the lower housing and upper housing being insulated from one another in a fluid-tight manner.

According to one of the aspects of the invention, the cooling plate or plates separate the lower housing from the upper housing.

According to one of the aspects of the invention, a plurality of cooling plates separate the lower housing from the upper housing, and these cooling plates are disposed in parallel rows.

According to one of the aspects of the invention, each cooling plate has a fluid inlet and a cooling fluid outlet which are each connected to one of the fluid connection elements, and these fluid inlets and outlets are all directed toward the lower housing.

Thus, in the event of a leak at these inlets and outlets, the cooling fluid flows into this lower housing, and not into the upper housing, so as to preserve the electrical components, in particular when these elements are battery cells.

Ducts are in particular provided within the cooling plates in order to circulate cooling fluid.

According to one of the aspects of the invention, the bottom cover comprises a cooling fluid channel, and the fluid connection element is connected to this channel.

According to one of the aspects of the invention, the bottom cover has a substantially planar main face.

According to one of the aspects of the invention, this bottom cover together with the cooling plates defines the lower housing.

According to one of the aspects of the invention, the lower and upper housings cover substantially the same surface area. These housings are thus in a stacked arrangement.

According to one of the aspects of the invention, the bottom cover has at least one layer of composite material based on polymer, in particular on plastic and thermoplastic material.

According to one of the aspects of the invention, the lower housing has, in free space, a height of less than 25%, in particular of less than 15%, of the height of the upper housing.

According to one of the aspects of the invention, a seal is disposed on a joining periphery between the lower housing and the upper housing.

According to one of the aspects of the invention, the upper housing has at least one frame, in particular made of aluminum, which defines a periphery of the upper housing, and the seal is in contact with this frame.

According to one of the aspects of the invention, this frame has external bars forming a periphery and partitions, which are in particular parallel to one another, for forming receptacles that are each intended to receive one battery cell. These partitions form, for example, two identical rows of multiple receptacles.

According to one of the aspects of the invention, the cooling plates are assembled on the frame by screwing or adhesive bonding, for example.

According to one of the aspects of the invention, one or more seals are provided between these bars and partitions of this frame on the one hand and the lower housing on the other hand.

According to one of the aspects of the invention, the seal or seals are disposed in a tight manner between a zone of the frame and a zone of a cooling plate, and/or between a zone of the frame and a zone of the bottom cover.

According to one of the aspects of the invention, the seal is made of electrically conductive material so as to contribute to an electromagnetic protection function (also referred to as EMC or electromagnetic compatibility) for the upper housing which receives the electrical component.

According to one of the aspects of the invention, the upper cover is designed to bear against the frame for closing of the compartment, in particular with the interposition of a seal, in particular made of electrically conductive material.

The invention allows for a total height of the compartment that is relatively low, which is advantageous given the size constraints. The compartment can also be manufactured in a simplified manner.

According to one of the aspects of the invention, the upper cover comprises a composite material based on plastics material.

The invention also relates to an electrical energy storage device having a plurality of battery cells, in particular disposed in a row, and a compartment as described previously, the cells being placed in the compartment in thermal interaction with the cooling plate.

### BRIEF DESCRIPTION OF THE DRAWINGS

Further features, details and advantages of the invention will become more clearly apparent upon reading the detailed description given below, and from several exemplary embodiments that are given by way of nonlimiting indication, with reference to the attached schematic drawings, in which:

FIG. 1 is a schematic side view of a compartment according to one example of the invention,

FIG. 2 shows the compartment of FIG. 1 in cross section,

FIG. 3 is a schematic view of a compartment according to another example of the invention,

FIG. 4 is a sectional view of FIG. 3,

FIG. 5 is another schematic view of FIG. 4, and

FIG. 6 is a sectional view of the compartment.

### DETAILED DESCRIPTION OF THE INVENTION

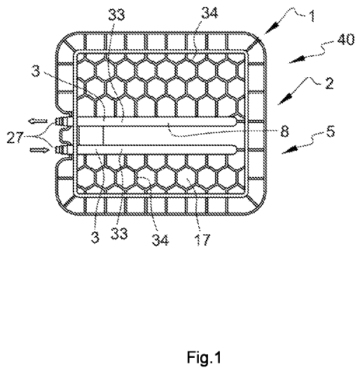

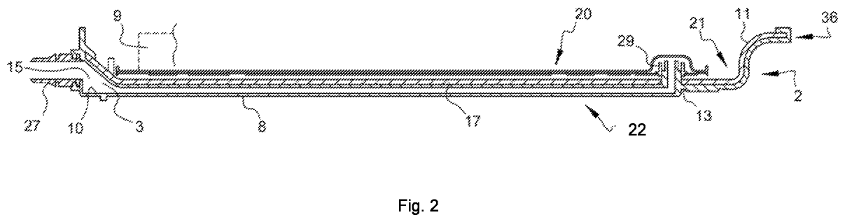

FIGS. 1 and 2 show an electrical energy storage module 1 having a plurality of battery cells 9, which are visible in FIG. 2, and a compartment 2.

The compartment 2 has two cooling fluid channels 3 for circulating a cooling fluid, which are visible in FIG. 1 and are parallel. FIG. 1 shows the lower and outer face of the compartment 2. The compartment 2 defines, together with an upper cover that is not shown, a casing 5 which contains the battery cells 9. The bottom of the casing 5 is on the compartment 2.

Each cooling fluid channel 3 is obtained by molding of a polymer-based material that can possibly comprise reinforcing fibers, with fluid-assisted injection molding, in particular gas- or liquid-assisted injection molding, for forming the cooling fluid channel 3 in the polymer-based material. Thus, the polymer-based material forms a first layer 8 of polymer material.

Each cooling fluid channel 3 has an internal wall 10 without a joint, which is the result of the hollowing of the polymer-based material by the fluid injected during the molding.

Each cooling fluid channel 3 has a cylindrical shape, at least over part of its length, in particular with a rectangular or oval or round cross section.

The first layer 8 of polymer material in which the cooling fluid channels 3 are formed is connected to a second layer 11 of composite material.

Composite material is understood to mean a material comprising at least two different materials such as plastic and metal. According to the invention, the preferred composite materials correspond to materials that are both robust and lightweight. Composite materials such as a mixture of a thermoplastic with reinforcing fibers are particularly well suited to such a use. By way of illustration, the composite material can correspond to polypropylene with glass and/or carbon fibers. Specifically, polypropylene corresponds to a lightweight material and the glass and/or carbon fibers reinforce the structure of the casing. Polyamide 6 with glass fibers is also possible. The composite material can also be said to correspond to reinforcing fibers pre-impregnated with a thermoplastic resin.

This connection is the result of overmolding or co-molding between the first layer 8 of polymer material and the second layer 11 of composite material, which has the cooling fluid channels 3 for circulating cooling fluid.

The second layer 11 of composite material has openings 13 and the first layer 8 of polymer material, which forms the cooling fluid channels 3, passes through these openings 13 such that each cooling fluid channel 3 also passes through the opening 13 associated with the second layer 11 of composite material.

The first layer 8 of polymer material in which the cooling fluid channel 3 is formed is in the form of a layer which extends over a face of the second layer 11 of composite material.

The second layer 11 of composite material is planar over at least part of its surface area in a planar region 17.

The first layer 8 of polymer material and the second layer 11 of composite material have an edge 15 that is inclined with respect to the planar region 17, and the cooling fluid channel 3 passes into the first layer 8 of polymer material at the edge 15.

Each cooling fluid channel 3 in the material is connected to a fluidic connection member 27 at the inclined edge 15.

Each fluidic connection member 27 is overmolded with the material of the first layer 8 of polymer material.

The compartment 2 has a cooling plate 20 disposed on a side 21 of the layer 11 of composite material that is opposite to the side 22 of the first layer 8 of polymer material.

The cooling plate 20 is designed to be passed through by a cooling fluid also circulating in the cooling fluid channels 3 of the first layer 8 of polymer material. These cooling fluid channels 3 are feeder channels which respectively supply and evacuate the cooling liquid circulating in the cooling plate 20. Provision is for example made for a single supply feeder channel and a single evacuation feeder channel.

The cooling plate 20 is formed of two sub-plates 24 which, once assembled, form a cooling fluid circulation circuit 39.

The first layer 8 of polymer material has connection portions 29 which are formed in one piece with the rest of the layer and which are designed to be connected to the cooling plate 20. The connection portion 29 protrudes through the layer 11 of composite material and is passed through by the associated cooling fluid channel 3 in order to lead the cooling fluid channel 3 up to the cooling plate 20. The cooling plate 20 faces the second layer 11 of composite material.

The first layer 8 of polymer material has grooves 33 for forming the cooling fluid channels 3 and reinforcing ribs 34, in particular of honeycomb shape, for mechanically reinforcing the compartment 2.

The fluid for the assisted injection molding can be water.

The first layer 8 of polymer material thus occupies only part of the outer face of the second layer 11 of composite material, and not all of this face. The first layer 8 of polymer material occupies for example less than 50% of the outer face of the second layer 11 of composite material, or even less than 25% thereof.

The cells 9 are placed in the compartment 2 in thermal interaction with the cooling plate 20.

Each cooling fluid channel 3 has a length of at least 5 cm, in particular of at least 10 cm.

The composite material of the second layer 11 of composite material comprises glass fibers, and possibly, in a variant, carbon fibers or fibers of another nature, which are pre-impregnated with a thermoplastic resin.

The compartment 2 has a raised edge 36 on its periphery.

The honeycomb structure 34 is toward the outside of the casing 5.

The cooling liquid used in this case can in particular be a liquid refrigerant based on carbon dioxide, such as R744 for example, 2,3,3,3-tetrafluoropropene (or HFO-1234yf) or 1,1,1,2-tetrafluoroethane (or R-134a). The cooling liquid can also be a nanofluid. The cooling liquid can also be water, possibly including additives.

The battery cells comprise, for example, a plurality of lithium-ion (Li-ion) batteries for use in a hybrid vehicle. In another embodiment, the plurality of battery cells are Li-ion batteries for use in a battery-powered electric vehicle.

The cooling plate 20 forms a heat exchanger comprised in a cooling circuit, not shown, of the type comprising a compressor and further heat exchangers.

The cooling plates 20 are, for example, an assembly of two aluminum walls delimiting ducts for circulating cooling fluid, taking the form of a meandering path, for example.

The compartment 2 and the battery cells 9 form, together with other components, an electrical energy storage device 40 for a motor vehicle.

The first layer 8 of polymer material and the second layer 11 of composite material form a bottom cover 88.

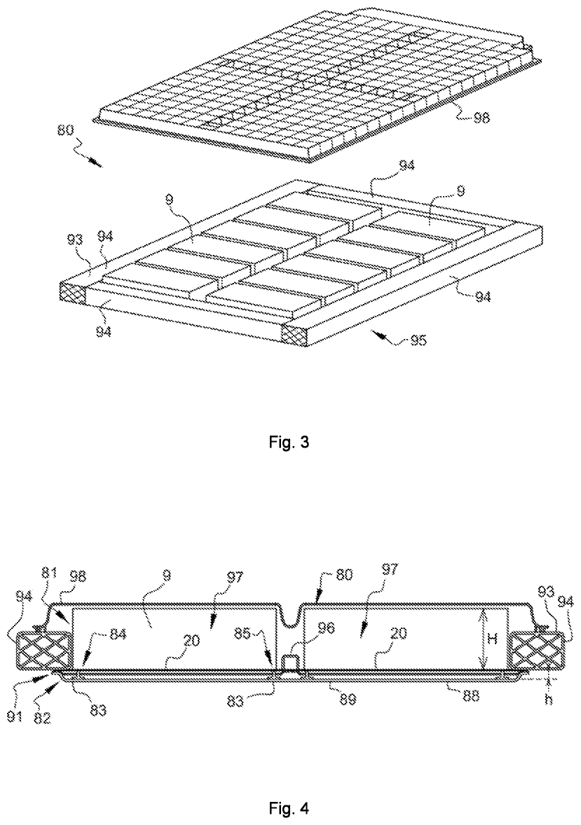

FIGS. 3 to 5 show a compartment 80 for battery cells 9 of a motor vehicle according to another embodiment. The compartment 80 has cooling plates 20 which are designed to be passed through by a cooling fluid and which are designed to cool the battery cells 9.

The compartment 80 furthermore has an upper housing 81 designed to receive the battery cells 9, and a lower housing 82 in which fluid connection elements 83 for supplying fluid to the cooling plates 20 are placed.

The lower housing 82 and the upper housing 81 are insulated from one another in a fluid-tight manner.

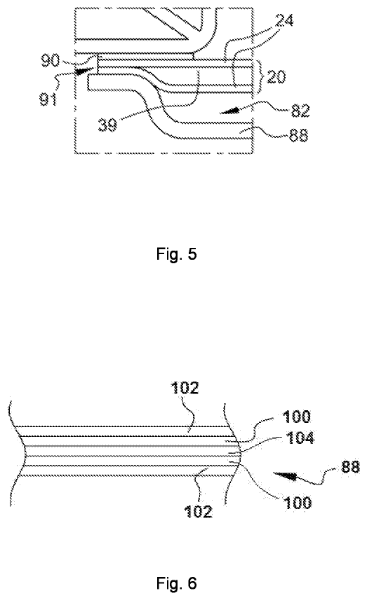

The cooling plates 20 separate the lower housing 82 from the upper housing 81, as can be better seen in FIGS. 4 and 5.

A plurality of cooling plates 20 separates the lower housing 82 from the upper housing 81, and these cooling plates 20 are disposed in parallel rows.

Each cooling plate 20 has a fluid inlet 84 and a cooling fluid outlet 85 which are each connected to one of the fluid connection elements 83, and these fluid inlets 84 and outlets 85 are all directed toward the lower housing 82.

Thus, in the event of a leak at these inlets 84 and outlets 85, the cooling fluid flows into the lower housing 82, and not into the upper housing 81, so as to preserve the battery cells 9.

Ducts are provided within the cooling plates 20 in order to circulate cooling fluid.

The compartment 80 has a bottom cover 88 comprising cooling fluid channels 3 like those described in the previous example.

The fluid connection elements 83 are connected to these cooling fluid channels 3, and are for example formed by a material extension that also forms the cooling fluid channels 3. These cooling fluid channels 3 are produced by fluid-assisted injection molding in the first layer 8 of polymer material, as described in the previous example.

The bottom cover 88 has a substantially planar main face 89.

The bottom cover 88 together with the cooling plates 20 defines the lower housing 82.

The lower housing 82 and the upper housing 81 cover substantially the same surface area. These housings 81 and 82 are thus in a vertically stacked arrangement when the assembly is mounted on the vehicle.

The bottom cover 88 has a layer of composite material based on polymer and more particularly plastic and thermoplastic.

The lower housing 82 has, in free space, a height h of less than 25%, in particular of less than 15%, of the height H of the upper housing 82.

Seals 90 are disposed on a joining periphery 91 between the lower housing 82 and the upper housing 81.

The upper housing 81 has an aluminum frame 93, which defines a periphery 95 of the upper housing, and the seal 90 is in contact with the frame 93.

The frame 93 has external bars 94 forming the periphery 95 and partitions 96, which form a grid, for forming receptacles 97 that are each intended to receive one battery cell 9. These partitions 96 form, for example, two identical rows of multiple receptacles 97.

The external bars 94 in particular have a cellular structure. The external bars 94 are for example made of steel or aluminum.

The cooling plates 20 are for example assembled on the frame 93 by screwing or adhesive bonding.

The seals 90 are provided between the external bars 94 and partitions 96 of the frame 93 on the one hand and the lower housing 82 on the other hand.

The seals 90, for example based on silicone, are disposed in a tight manner between a zone of the frame 93 and a zone of a cooling plate 20, and/or between a zone of the frame 93 and a zone of the bottom cover 88.

Each seal 90 is made of electrically conductive material so as to contribute to an electromagnetic protection function for the upper housing 81 which receives the battery cells 9.

An upper cover 98 is designed to bear against the frame 93 for closing of the compartment, with the interposition of seals 90.

The upper cover 98 comprises a composite material based on polymer material, and in particular has a substantially flat shape.

The feeder cooling fluid channels 3 are in particular directed toward the lower housing 82.

Regardless of the embodiment described above, the invention relates to the sealing of the compartment 2, 80 and in particular to the sealing of the bottom cover 88. As illustrated in FIG. 6, the bottom cover 88 corresponds to a multi-layer structure comprising at least one layer 100 of composite material and an additional layer 102 of non-reinforced polymer material. The additional layer 102 of non-reinforced polymer material corresponds, for example, to plastic or other thermoplastic without any reinforcing fibers. The additional layer 102 of non-reinforced polymer material is preferably impermeable to the cooling fluid in order to guarantee the sealing of the bottom cover 88. In other words, the additional layer 102 of non-reinforced polymer material is made of, or manufactured from, a material that is impermeable to a liquid refrigerant such as R744, HFO-1234yf, R-134a or water.

Non-reinforced polymer material is understood to mean a preferably thermoplastic material having no reinforcing fibers. In order to facilitate the affinity between the layers, it is preferable for the polymer, in other words the thermoplastic, of the additional layer 102 of non-reinforced polymer material to be the same as that of the layer 100 of composite material. Of course, affinity is possible between different polymers, for example chemically compatible polymers, or else polymers connected by forming a complex or by prior treatment of the first and second layers, or both of the above.

The bottom cover 88 can furthermore comprise other layers. As illustrated in FIG. 6, the bottom cover 88 can comprise a layer corresponding to a fire barrier 104.

According to one of the aspects of the invention, the fire barrier 104 is formed by one of the following elements:
a fireproof film, in particular made of plastic, in particular thermoplastic, with suitable adjuvants,
a layer comprising aramid, for example a woven fabric layer,
a metal layer or foil.

According to one of the aspects of the invention, the fire barrier 104 is a layer that is incorporated in the multi-layer structure of the bottom cover 88.

The fire barrier 104 is formed at the same time as the other layers 100, 102 of the multi-layer structure, for example.

As illustrated in FIG. 6, the bottom cover 88 can comprise a plurality of layers. For example, the bottom cover 88 can comprise two layers 100 of composite material and two additional layers 102 of non-reinforced polymer material, possibly with a fire barrier 104 arranged centrally between these four layers.

According to other embodiments that are not illustrated, the bottom cover 88 can comprise a layer 100 of composite material and two additional layers 102 of non-reinforced polymer material on either side of this layer 100 of composite material, possibly with a fire barrier layer 104.

However, according to the invention, in order to ensure improved sealing and to prevent any leakage of cooling fluid, it is preferable for the outer layer of the bottom cover 88, that is to say the layer directed toward the bottom of the vehicle, or the layer directed in the direction opposite to the battery cells 9, to be the additional layer 102 of non-reinforced polymer material. In the case where there are two additional layers 102 of non-reinforced polymer material, it is also possible for the outer layer and the inner layer, that is to say the layer directed toward the battery cells 9, to both be additional layers 102 of impermeable non-reinforced polymer material.

According to one of the aspects of the invention that is not illustrated, a second fire barrier 104 is provided in the form of an inner layer of the compartment 2, 80, in particular a layer directed toward the battery cells 9 to be housed in said compartment 2, 80. Thus, two fire barriers 104 can be provided on the two faces, inner and outer faces, of the compartment 2, 80 so as to reinforce the fire protection of the compartment 2, 80.

The fire barrier 104 extends over the entire bottom cover 88, in particular over the outside thereof.

According to the first embodiment, the second layer 11 of composite material corresponds to the first layer 100 of composite material, and the first layer 8 of polymer material corresponds to the additional layer 102 of non-reinforced polymer material.

One aspect according to the invention provides that the upper cover 98 has the same multi-layer structure as the bottom cover 88.

What is claimed is:

1. A compartment for an item of equipment liable to give off heat during its operation, in particular for an electrical energy storage device for a motor vehicle, the compartment having at least one cooling plate which is designed to be passed through by a cooling fluid and which is designed to cool said item of equipment, the compartment comprising a bottom cover with at least one layer of composite material and a primary additional layer of non-reinforced polymer material.

2. The compartment as claimed in claim 1, wherein the bottom cover includes a secondary additional layer of non-reinforced polymer material, the at least one layer of composite material being arranged between the primary additional layer of non-reinforced polymer material and the secondary additional layer of non-reinforced polymer material.

3. The compartment as claimed in claim 1, wherein the compartment furthermore has an upper housing designed to receive said item of equipment, and a lower housing defined by the bottom cover together with the at least one cooling plate, in which at least one fluid connection element for supplying the cooling fluid to the at least one cooling plate is placed, the lower housing and upper housing being insulated from one another in a fluid-tight manner.

4. The compartment as claimed in claim 3, wherein the at least one cooling plate separates the lower housing from the upper housing.

5. The compartment as claimed in claim 4, wherein the bottom cover includes a cooling fluid channel, and the at least one fluid connection element is connected to the cooling fluid channel.

6. The compartment as claimed in claim 5, wherein a seal is disposed on a joining periphery between the lower housing and the upper housing.

7. The compartment as claimed in claim 6, wherein the upper housing has at least one frame, in particular made of aluminum, which defines a periphery of the upper housing, and the seal is in contact with the at least one frame.

8. The compartment as claimed in claim 7, wherein the seal is disposed in a tight manner between a zone of the at least one frame and a zone of the at least one cooling plate, and between a zone of the at least one frame and a zone of the bottom cover.

9. The compartment as claimed in claim 6, wherein an upper cover is provided to bear against the at least one frame for closing of the compartment, in particular with the interposition of the seal, in particular made of electrically conductive material.

10. An electrical energy storage device having
a plurality of battery cells that are in particular disposed in a row,
and a compartment for an item of equipment liable to give off heat during its operation, in particular for an electrical energy storage device for a motor vehicle, the compartment having at least one cooling plate which is designed to be passed through by a cooling fluid and which is designed to cool said item of equipment, the compartment comprising a bottom cover with at least one layer of composite material and a primary additional layer of non-reinforced polymer material,
said battery cells being placed in the compartment in thermal interaction with the cooling plate.

11. The compartment as claimed in claim 7, wherein the seal is disposed in a tight manner between a zone of the frame and a zone of a cooling plate, or between a zone of the frame and a zone of the bottom cover.
